(19) United States
(12) Patent Application Publication
(10) Pub. No.: US 2005/0261960 A1
(43) Pub. Date: Nov. 24, 2005

(54) Automobile dealership advertising and affinity program

(76) Inventor: Jim Hoffey, Brookfield, MA (US)

Correspondence Address: SAMPSON & ASSOCIATES, P.C., 50 CONGRESS STREET, BOSTON, MA, 02109, US

(21) Appl. No.: 10/851,262

(22) Filed: May 21, 2004

(51) Int. Cl. G06F 17/60

(52) U.S. Cl. 705/14; 40/591

(57) ABSTRACT

A method is provided for enhancing automobile inventory at an automobile dealership. The method includes providing a plurality of substantially identical emblems configured to be substantially permanently installed on a glass portion of an automobile, and which are sized and shaped to permit unobstructed operation of the automobile when installed. The emblems are permanently installed on substantially the entire inventory of an automobile dealership, with installation repeated at periodic intervals to ensure that the emblems are disposed on substantially the entire inventory as the inventory is replenished. Discounts on fixed operations at the dealership are provided to purchasers who retain the emblems on their purchased automobiles. The method enhances the pre-sale presentation of automobiles, expands the geographic visibility of the dealership by providing indicia that remains on automobiles pre-sale and post-sale, and enhances fixed operations of the dealership.

### BACKGROUND

1. Technical Field

This invention relates to an automobile customization and advertising system and method, and more particularly to a system for customizing an automobile, in a manner that provides pre-sale advertising, expands the geographic visibility of the dealership both pre-sale and post-sale, and enhances fixed operations of the dealership post-sale.

2. Background Information

Throughout this application, various publications, patents and published patent applications are referred to by an identifying citation. The disclosures of the publications, patents and published patent applications referenced in this application are hereby incorporated by reference into the present disclosure.

Automobile dealerships, particularly those selling new automobiles, are faced with competitive pressures today that perhaps exceed those faced at any other time in the past. Historically, many new car dealers were able to rely on receiving a particular amount of business based simply on their geographic location. Indeed, new vehicle manufacturers generally avoided awarding franchises to dealerships located too close to one another for fear of creating competitive pressures so severe as to threaten their survival. This practice helped insure that dealerships would receive some level of profitable business from local customers. Customers have often preferred to do business with a local dealership due to perceived advantages in terms of completing the often lengthy sales process, including test drives, and face-to-face negotiations with salespeople. There were also perceived advantages in terms of conveniently receiving post-sale services such as warranty work, repairs, fluid replacement (e.g., oil, windshield washer fluid) and the like. Dealerships commonly refer to these post-sale activities as ‘fixed operations’.

In recent years, however, developments such as electronic commerce and the substantial improvement in initial quality, has made it easier for customers to purchase vehicles from distant dealerships. Indeed, many new vehicles are purchased today without any face-to-face contact. Many sales are initiated and completed solely on the basis of information posted by dealerships on websites such as e-baymotors.com. In part because these selling dealerships know they will not be responsible for low-margin post-sale warranty work or other post-sale customer service to distant purchasers, these vehicles are often sold at discount prices that local dealerships focused on providing higher levels of customer service often cannot match.

For this reason, local community dealerships have actively sought approaches to promote and capitalize on the advantages of their location. One long-standing and relatively simple approach has been to place highly visible advertising indicia on the windshields of automobiles in inventory. This indicia typically includes information such as price, financing rates, warranty information, and the like. The indicia is often written or painted directly onto the windshields in a manner that allows the automobile to be test-driven without removal. Alternatively, such indicia has been placed on banners locatable along the top edge of the windshield.

An example of such a banner is disclosed in U.S. Pat. No. 6,640,477 which includes various information such as price, manufacturer and model, financing options, warranty information, and the like.

This approach, however, disadvantageously supports only one facet of the dealership's business, i.e., that of new car sales.

Other advertising approaches have focused on encouraging repeat sales of various products and services. Examples of these approaches include frequent flier programs that reward customers for patronizing a particular airline, and credit card programs that provide ‘cash back’ or discounted products to customers who use those credit cards for purchases.

One such system disclosed in U.S. Pat. No. 6,374,228 provides rebates on various items to users who place advertisements on their clothing (e.g., T-shirts, hats) or affix bumper stickers to their cars. In this system, advertisers provide displays such as bumper stickers, and the vehicle operator or other user receives a rebate or discount when the advertisement display is detected at a participating retail or service establishment. This system relies on a relatively complex computer implemented tracking system and database, which includes detectors located at the participating establishments to detect the presence of the advertisement on a person or vehicle, and communication means that connect the detectors to a centralized database computer to properly credit an individual's account.

While these approaches may be well received in some industries, such as airlines, they have not been as well received in others. The '288 patent appears to address this shortcoming, by attempting to apply the affinity concept to a wide range of products and services. However, the '288 system is disadvantageously complex, due to the need for a relatively large number of networked detection sensors. Moreover, as discussed in the '228 patent, relatively elaborate measures must be taken to guard against fraud. Still further, use of a ubiquitous detector network as described may meet resistance by consumers due to privacy concerns. It may also be difficult to quantify the benefits of such a system, in terms of increased sales directly attributable thereto.

Thus, a need exists for a system specifically tailored to automobile dealerships, that addresses drawbacks of the prior art.

### SUMMARY

One aspect of the present invention includes a method for simultaneously enhancing the pre-sale presentation of automobiles at an automobile dealership, expanding the geographic visibility of the dealership pre-sale and post-sale, and enhancing fixed operations of the dealership post-sale. The method includes providing a plurality of substantially identical emblems configured as multi-part, weatherproof, self-adhering decals which collectively form decorative indicia associated with the dealership. The emblems are configured for substantially permanent installation along an upper margin of an automobile windshield, and are sized and shaped to permit an unobstructed view of the road from the driver's seat of the automobile. The method further includes permanently installing the emblems along the upper margin of an exterior surface of the windshields of substantially the entire inventory of an automobile dealership, and repeating at periodic intervals to ensure that the emblems are disposed on substantially the entire inventory as the inventory is replenished. Discounts are provided on fixed operations at the dealership to purchasers who retain the emblems on their purchased automobiles. The method thus enhances the pre-sale presentation of automobiles, expands the geographic visibility of the dealership by providing indicia that remains on automobiles pre-sale and post-sale, and enhances fixed operations of the dealership.

Another aspect of the invention includes a method for enhancing automobile inventory at an automobile dealership. The method includes providing a plurality of substantially identical emblems configured to be substantially permanently installed on a glass portion of an automobile. The emblems are sized and shaped to permit unobstructed operation of the automobile when installed. The emblems are permanently installed on substantially the entire inventory of an automobile dealership. The installation is repeated at periodic intervals to ensure that the emblems are disposed on substantially the entire inventory as the inventory is replenished. Discounts on fixed operations at the dealership are provided to purchasers who retain the emblems on their purchased automobiles. The method thus enhances the pre-sale presentation of automobiles, expands the geographic visibility of the dealership by providing indicia that remains on automobiles pre-sale and post-sale, and enhances fixed operations of the dealership.

A further aspect of the present invention includes a method for enhancing automobile inventory at an automobile dealership. This method includes providing a plurality of substantially identical emblems configured to be substantially permanently installed on a glass portion of an automobile. The emblems are sized and shaped to permit unobstructed operation of the automobile. The method also includes providing instructions to permanently install the emblems on substantially the entire inventory of an automobile dealership, and to repeat the installation at periodic intervals to ensure that the emblems are disposed on substantially the entire inventory as the inventory is replenished. Further steps include providing promotional materials for distribution to customers, which describes discounts on fixed operations at the dealership for purchasers who retain the emblems on their purchased automobiles; and sending the emblems, instructions, and promotional materials to the dealership. The method thus enhances the pre-sale presentation of automobiles, expands the geographic visibility of the dealership by providing indicia that remains on automobiles pre-sale and post-sale, and enhances fixed operations of the dealership.

A still further aspect of the invention includes a method for enhancing automobile inventory at an automobile dealership. This method includes receiving a plurality of substantially identical emblems, each of the emblems configured to be substantially permanently installed on a glass portion of an automobile, and sized and shaped to permit unobstructed operation of the automobile. The emblems are permanently installed on substantially the entire inventory of an automobile dealership. This installation is repeated at periodic intervals to ensure that the emblems are disposed on substantially the entire inventory as the inventory is replenished. Discounts are provided on fixed operations at the dealership to purchasers who retain the emblems on their purchased automobiles. This method enhances the pre-sale presentation of automobiles, expands the geographic visibility of the dealership by providing indicia that remains on automobiles pre-sale and post-sale, and enhances fixed operations of the dealership.

### BRIEF DESCRIPTION OF THE DRAWINGS

The above and other features and advantages of this invention will be more readily apparent from a reading of the following detailed description of various aspects of the invention taken in conjunction with the accompanying drawings, in which:

FIG. 1 is a perspective view of an automobile dealership including aspects of the present invention; and

FIG. 2 is a view, on a larger scale, of an automobile including aspects of FIG. 1.

### DETAILED DESCRIPTION

In the following detailed description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized. It is also to be understood that structural, procedural and system changes may be made without departing from the spirit and scope of the present invention. The following detailed description is, therefore, not to be taken in a limiting sense, and the scope of the present invention is defined by the appended claims and their equivalents. For clarity of exposition, like features shown in the accompanying drawings shall be indicated with like reference numerals and similar features as shown in alternate embodiments in the drawings shall be indicated with similar reference numerals.

Referring to the Figures, embodiments of the present invention are shown. Briefly described, an embodiment of the invention includes a method for simultaneously enhancing the pre-sale presentation of automobiles at an automobile dealership, expanding the geographic visibility of the dealership pre-sale and post-sale, and enhancing fixed operations of the dealership post-sale. This method includes providing a plurality of substantially identical emblems in the form of multi-part, weatherproof decals which collectively form decorative indicia associated with the dealership. The emblems are permanently installed along an upper margin of the windshields of nominally the entire vehicle inventory.

The emblems are configured to attractively customize, and add a premium or ‘designer label’ status to the vehicles. The emblems also tend to enhance the presentation and customer recognition of the source of the inventory.

Embodiments of the present invention also include periodically checking the auto dealer's current inventory to ensure that the emblems are disposed on substantially the entire inventory as the inventory is replenished. Moreover, customers who purchase automobiles from the dealership and who keep the emblems on their vehicles are provided with incentives to return to the dealership post-sale for discounted fixed operations services.

Thus, embodiments of the present invention advantageously address the full spectrum of dealership activities, by simultaneously enhancing the pre-sale presentation of automobiles, enhancing traffic and sales to the fixed operations of the dealership, and by expanding the effective geographic visibility of the dealership by providing indicia that remain on automobiles pre-sale and post-sale.

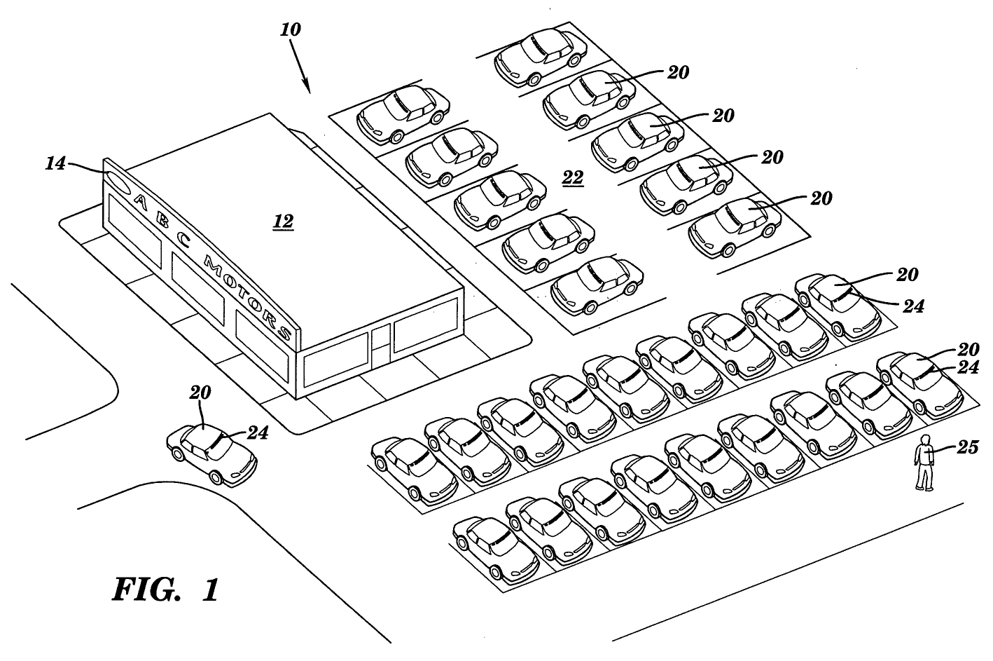

Referring now to the figures and Table, embodiments of the present invention will be more thoroughly described. As shown in FIG. 1, an auto dealership 10 typically includes one or more showrooms 12 to display a representative sampling of particular makes and models of available vehicles. The balance of the dealership's inventory, which may consist of hundreds or even thousands of vehicles 20, is typically located on various lots 22. Accordingly, much of the inventory is often located some distance away from the showroom(s) 12, and from signage 14 identifying the dealership. As shown, in embodiments of the present invention, nominally each of the vehicles 20 is provided with at least one emblem 24 disposed along the upper margin of its windshield 26. Such placement of emblems 24 tends to improve the overall presentation of the dealership and its inventory, while perhaps more importantly, effectively creating new signage, at little added expense, to expand the geographic reach of signage 14 (e.g., to the far reaches of the lots 22). The emblems 24 thus serve to identify the dealership 12 to passers-by 25 who may not be able to view the signage 14 located at the showroom 12.

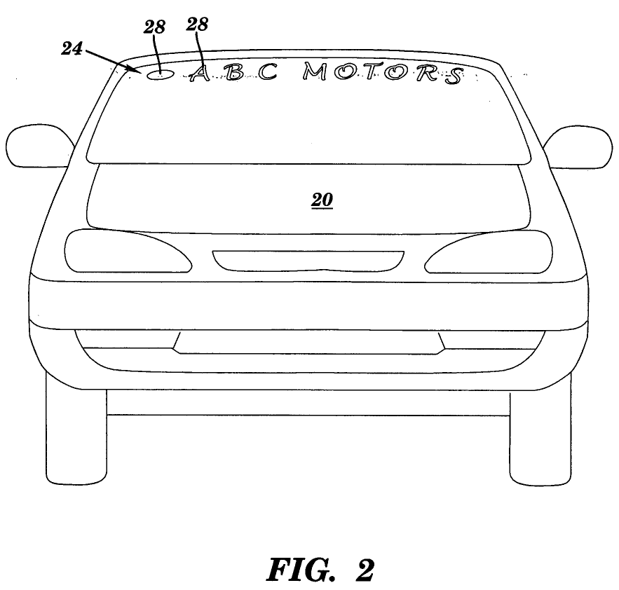

Turning now to FIG. 2, each emblem 24 may be fabricated in multiple parts, such as a series of individual weatherproof decals 28 fabricated as alphanumeric and/or graphical indicia in nominally any color or color combination, and in nominally any customized font, style and shape. In particular embodiments, this indicia forms a trademark, service mark, and/or logo (collectively, the ‘mark’) of dealership 10. In some embodiments emblem 24 is deliberately limited to the mark of the dealership 10, so that nominally the same emblem 24 may be placed on substantially all vehicles 20 in the dealership's inventory. This facilitates installation, while also providing a uniform appearance which carries across the entire inventory, regardless of make and model of vehicles 20 sold by dealership 10. Moreover, the exclusion of various additional information, such as the warranty, and financing information, etc., commonly used in the prior art, enhances the aesthetic appeal of the emblem 24, and improves the chances that the purchaser of a particular vehicle 20 will choose to leave the emblem 24 on the vehicle after purchase, as discussed in greater detail below.

In fact, it is envisioned that emblem 24 may be crafted in a sufficiently aesthetically pleasing manner as to become a sought-after customization or status-symbol, not unlike pin-striping, designer labels, or the NIKE® Swoosh trademark.

Embodiments of emblem 24 may be fabricated using widely available equipment and materials, such as sign fabrication systems available from Summa, Inc. of Seattle, Wash., USA. These systems typically include a personal computer (e.g., a win/tel machine utilizing an Intel® processor running a Microsoft® Windows™ operating system), running sign making software, and connected to a cutter for cutting conventional pressure sensitive adhesive vinyl film.

It should be pointed out that emblems 24 may be fabricated from a translucent vinyl adhesive sheet material. The translucent emblems 24 may then function as a sunscreen, thereby reducing or eliminating the dealership's need to purchase inventory having windshields of the type with integral tinted sunscreens along the upper margin thereof. Even in the event the inventory already has such integral sunscreens, such translucent emblems 24 may be superimposed therewith, to advantageously enhance the sun screening performance thereof.

The following illustrative example is intended to demonstrate certain aspects of the present invention. It is to be understood that this example should not be construed as limiting.

### EXAMPLE 1

Emblems 24 were produced as described hereinabove, using the following:
SummaCut™ D-Series Cutter D620-IE (Summa, Inc.);
Win/tel personal computer;
SummaCut™ Media Support System D620 (Summa, Inc.);
CoCut 9 PRO™ sign making software (CoCut Software, Inc.);
Smart Designer™ 9-R (SD9-R) Graphic Design Software (Digital Art Solutions, Tempe, Ariz., USA);
Smart Templates™ formatted design templates and clip art for Smart Designer™ 9 (Digital Art Solutions);
Smart Logos™ production-ready corporate logos, trademarks and symbols (Digital Art Solutions);
Power Graphics™ Vol. 1 package for creating custom graphics and logos (Digital Art Solutions);
WeberMade Single Shaft Tape Tool (WeberMade, Carlos, Minn., USA);
Application/Transfer Tape; and
MACmark® 5-7 year outdoor CAS (Computer Aided Signage) pressure sensitive adhesive film (MACtac® Americas, Stow, Ohio, USA).

The emblems 24 produced by this system were affixed to the windshields 26 of vehicles 20 as described herein.

It is contemplated that this equipment may be located at a site away from dealership 10, where emblems 24 are fabricated and then sent to the dealership by courier (e.g., U.S. Postal Service or private courier), for installation by dealership personnel. Alternatively, the emblems may be fabricated and then transported to the dealership by the installers themselves. As a still further alternative, the emblem fabrication equipment may be installed in a vehicle such as a van, so that the installer may fabricate the emblems on-site. Those skilled in the art will recognize that the van may be equipped with a conventional inverter to convert the vehicle's 12 volt D.C. power to 120 volt A.C. to operate the cutter on board the van. A conventional laptop personal computer may be powered either by its own battery, or directly by the van's 12 volt D.C. power supply. Benefits of such on-site fabrication include the ability to produce as many emblems as needed on a real-time basis, i.e., without the need for a first visit to the dealership to obtain a count of the number of emblems required, and for a second visit to deliver and/or install the emblems, as discussed in greater detail hereinbelow. This on-site fabrication also enables the user to reduce or nominally eliminate waste, by eliminating any need to fabricate more emblems than actually needed at the time of installation.

Having described aspects of the invention, the following is a description of the methodology thereof. Referring to Table 1, an embodiment of the present invention includes, at 40, providing a plurality of substantially identical emblems 24 sized and shaped 42 for installation along the upper margin of a windshield 26 so that they permit an unobstructed view of the road from the driver's seat of the automobile. As described above, emblems 24 may be fabricated from a translucent vinyl adhesive sheet material to enhance driver visibility while also serving as a sunscreen, to reduce or eliminate the need for purchasing relatively expensive windshields of the type having integral tinted sunscreens along the upper margin thereof.

As also mentioned above, the emblems are configured 44 for substantially permanent installation on the windshield. As used herein, the term ‘permanent’ refers to any installation which is not readily removable, and/or which is likely to remain in place for a length of time corresponding to a substantial portion of the useful life of the vehicle and/or windshield to which it is installed. For example, emblems 24 fabricated from a material rated for a 3-5 or 5-7 year life would be considered ‘permanent’ as used herein.

At 46, the emblems 24 are installed along an upper margin of the windshields 26 of substantially the entire inventory of an automobile dealership. At 48, step 46 is repeated at periodic intervals to ensure that the emblems 24 are disposed on substantially the entire inventory as the inventory is alternately sold and replenished. Step 50 includes offering and providing discounts on fixed operations (e.g., provided at dealership 10) as a reward to purchasers who retain emblems 24 on their purchased automobiles. Step 50 may be accomplished through the use of any number of approaches, such as via flyers given to purchasers at the time of sale of vehicles 20, via mailings, and/or by placards or other signage located at the dealership 10.

This method obviates the need for elaborate detection and/or fraud-prevention means such as required by the prior art discussed above. Such a need is eliminated because the reward itself (e.g., discounted oil changes, repairs, etc.) is applied directly to the vehicle 20 on which emblem 24 is affixed, and because the benefit received by the dealership (advertising displayed on the customer's vehicle and business for its fixed operations) has self-evidently been received simply by virtue of the fact that the advertising-laden vehicle 20 is being serviced. Advantages of embodiments of the present invention are thus multi-faceted. They include simultaneously enhancing the pre-sale presentation and/or function of inventoried automobiles, and expanding the geographic visibility of the dealership pre-sale, by virtue of the dealership's indicia being placed on a highly visible location on each inventoried vehicle 20. This advantageously enables the vehicles to function as billboards that effectively expand the geographic reach of the dealership's signage beyond that of the showroom 12, effectively up to the borders of its lots 22.

The geographic visibility of the dealership is further enhanced both pre-sale and post-sale by structuring both the emblems and the reward program so that the emblems remain on the vehicles 20 as they are driven pre- and post-sale, such as shown in FIG. 1. Advantageously, the vehicles serve as mobile billboards that effectively expand the geographic reach of the dealership well beyond the borders of its lots 22.

Still further, and perhaps most significantly, these embodiments are capable of inexpensively and verifiably driving business to the dealership's fixed operations, to provide a direct revenue benefit to the dealership 10.

TABLE I

| | |
|---|---|
| 40 | providing a plurality of substantially identical emblems |
| | 24 with mark of dealership 10 |
| 42 | Sizing and shaping emblems for installation along the |
| | upper margin of a windshield to permit an unobstructed |
| | view from automobile. |
| 44 | Configuring emblems for substantially permanent |
| | installation. |
| 46 | Installing emblems along upper margin of the windshields |
| | 26 of substantially the entire inventory of an automobile |
| | dealership. |
| 48 | Repeating step 48 to ensure that the emblems 24 are |
| | disposed on substantially the entire inventory as the |
| | inventory is alternately sold and replenished. |
| 50 | Offering and providing discounts on fixed operations to |
| | purchasers who retain emblems 24 on their purchased |
| | automobiles. |

It is contemplated that aspects of the instant invention, such as fabrication, delivery, installation, and periodic repeat visits to the dealership to install emblems on new inventory, are provided as a service to auto dealerships. However, the skilled artisan should realize, in view of the teachings hereof, that any portion of these embodiments may be implemented by third parties, and/or by the dealerships themselves, without departing from the spirit and scope of the present invention.

It is also contemplated that emblems 24 of the present invention may be installed on an exterior surface of windshield 26 for ease of installation. However, those skilled in the art should recognize that emblems 24 may be installed on an interior surface of the automobile without departing from the spirit and scope of the present invention.

In the preceding specification, the invention has been described with reference to specific exemplary embodiments thereof. It will be evident that various modifications and changes may be made thereunto without departing from the broader spirit and scope of the invention as set forth in the claims that follow. The specification and drawings are accordingly to be regarded in an illustrative rather than restrictive sense.

1. A method for simultaneously enhancing the pre-sale presentation of automobiles at an automobile dealership, expanding the geographic visibility of the dealership pre-sale and post-sale, and enhancing fixed operations of the dealership post-sale, said method comprising:
(a) providing a plurality of substantially identical emblems;
(b) configuring each of the emblems as multi-part, weatherproof, self-adhering decals which collectively form decorative indicia associated with the dealership;
(c) configuring each of the emblems to be installed along an upper margin of an automobile windshield;
(d) configuring each of the emblems to be substantially permanently installed on an exterior surface of the windshield;
(e) sizing and shaping each of the emblems to permit an unobstructed view of the road from the driver's seat of the automobile;
(f) permanently installing the emblems along the upper margin of an exterior surface of the windshields of substantially the entire inventory of an automobile dealership;
(g) repeating said permanently installing (f) at periodic intervals to ensure that the emblems are disposed on substantially the entire inventory as the inventory is replenished; and
(h) providing discounts on fixed operations at the dealership to purchasers who retain the emblems on their purchased automobiles;
wherein said method enhances the pre-sale presentation of automobiles, expands the geographic visibility of the dealership by providing indicia that remains on automobiles pre-sale and post-sale, and enhances fixed operations of the dealership.

2. A method for enhancing automobile inventory at an automobile dealership, the method comprising:
(a) providing a plurality of substantially identical emblems;
(b) configuring each of the emblems to be installed on a glass portion of an automobile;
(c) configuring each of the emblems to be substantially permanently installed;
(d) sizing and shaping each of the emblems to permit unobstructed operation of the automobile;
(e) permanently installing the emblems on substantially the entire inventory of an automobile dealership;
(f) repeating said permanently installing (e) at periodic intervals to ensure that the emblems are disposed on substantially the entire inventory as the inventory is replenished; and
(g) providing discounts on fixed operations at the dealership to purchasers who retain the emblems on their purchased automobiles;
wherein said method enhances the pre-sale presentation of automobiles, expands the geographic visibility of the dealership by providing indicia that remains on automobiles pre-sale and post-sale, and enhances fixed operations of the dealership.

3. The method of claim 2, wherein the emblems comprise indicia associated with the dealership.

4. The method of claim 2, further comprising:
configuring each of the emblems as multi-part, weatherproof decals which collectively form decorative indicia associated with the dealership.

5. The method of claim 2, wherein the emblems are configured for installation on an exterior surface of the glass portion.

6. The method of claim 5, wherein the emblems are installed on an exterior surface of the glass portion.

7. The method of claim 2, wherein the glass portion comprises a windshield.

8. The method of claim 7, wherein said permanently installing (e) comprises installing the emblems along an upper margin of the windshields of substantially the entire inventory.

9. The method of claim 8, wherein the emblems are installed on a exterior surface of the windshields.

10. The method of claim 2, wherein the emblems each comprise a sunscreen.

11. The method of claim 10, wherein the emblems are translucent.

12. The method of claim 2, comprising:
providing a dual incentive in which customers are encouraged to retain the emblem on the automobile after purchase, and to return to the dealership for fixed operations.

13. The method of claim 2, wherein the fixed operations comprise automobile repairs and services.

14. The method of claim 2, wherein the indicia identifies the dealership.

15. The method of claim 14, wherein the indicia comprises a trademark, service mark, or trade dress of the dealership.

16. The method of claim 2, wherein the emblems are configured to be self-adhering.

17. The method of claim 2, wherein said steps (a) through (d) are effected off-site.

18. The method of claim 2, wherein said steps (a) through (d) are effected at the dealership.

19. The method of claim 18, further comprising effecting said steps (a) through (d) in a vehicle having emblem fabricating equipment disposed therein.

20. The method of claim 2, wherein said emblems comprise polymeric sheet material in the form of a plurality of discrete indicia having an adhesive disposed on one side thereof.

21. A method for enhancing automobile inventory at an automobile dealership, the method comprising:
(a) providing a plurality of substantially identical emblems;
(b) configuring each of the emblems to be installed on a glass portion of an automobile;
(c) configuring each of the emblems to be substantially permanently installed;
(d) sizing and shaping each of the emblems to permit unobstructed operation of the automobile;
(e) providing instructions to permanently install the emblems on substantially the entire inventory of an automobile dealership, and to repeat the installation at periodic intervals to ensure that the emblems are disposed on substantially the entire inventory as the inventory is replenished;
(f) providing promotional materials for distribution to customers, which describes discounts on fixed operations at the dealership for purchasers who retain the emblems on their purchased automobiles; and
(g) sending the emblems, instructions, and promotional materials to the dealership;
wherein said method enhances the pre-sale presentation of automobiles, expands the geographic visibility of the dealership by providing indicia that remains on automobiles pre-sale and post-sale, and enhances fixed operations of the dealership.

22. A method for enhancing automobile inventory at an automobile dealership, the method comprising:
(a) receiving a plurality of substantially identical emblems, each of said emblems:
configured to be substantially permanently installed on a glass portion of an automobile;
sized and shaped to permit unobstructed operation of the automobile;
(b) permanently installing the emblems on substantially the entire inventory of an automobile dealership;
(c) repeating said permanently installing (b) at periodic intervals to ensure that the emblems are disposed on substantially the entire inventory as the inventory is replenished; and
(d) providing discounts on fixed operations at the dealership to purchasers who retain the emblems on their purchased automobiles;
wherein said method enhances the pre-sale presentation of automobiles, expands the geographic visibility of the dealership by providing indicia that remains on automobiles pre-sale and post-sale, and enhances fixed operations of the dealership.
